(19) United States
(12) Patent Application Publication
(10) Pub. No.: US 2024/0423216 A1
(43) Pub. Date: Dec. 26, 2024

(54) COMPOSITIONS FOR CONTROLLING ARTHROPODS

(71) Applicant: The Procter & Gamble Company, Cincinnati, OH (US)

(72) Inventors: Michael David O'Young MUI, Mason, OH (US); Morgan Renee SAILOR, Cincinnati, OH (US)

(21) Appl. No.: 18/746,128

(22) Filed: Jun. 18, 2024

Related U.S. Application Data
(60) Provisional application No. 63/509,339, filed on Jun. 21, 2023.

(51) Int. Cl. A01N 65/44; A01N 25/04; A01N 31/02; A01N 65/22; A01P 7/00

(52) U.S. Cl. CPC A01N 65/44; A01N 25/04; A01N 31/02; A01N 65/22; A01P 7/00

(57) ABSTRACT

The present disclosure relates to pesticidal compositions and to methods for controlling pests, such as insects and other arthropods. More particularly, the disclosure relates to a pesticidal composition that leaves less residue on a treated surface, while providing efficacious control of arthropods, even on food, food contact surfaces, or surfaces adjacent to food contact surfaces. The pesticidal composition may comprise from about 4% to about 9%, by weight of the composition, of sodium lauryl sulfate, from about 0.3% to about 2%, by weight of the composition, of a first active ingredient, from about 3% to about 35%, by weight of the composition, of isopropyl alcohol, and from about 65% to about 85%, by weight of the composition, of water. The first active ingredient may be lemongrass oil. The pesticidal composition may have a pH of about 3.0 to about 9.0.

### CROSS REFERENCE TO RELATED APPLICATIONS

This application claims the benefit, under 35 U.S.C. § 119(e), to U.S. Provisional Application No. 63/509,339, filed Jun. 21, 2023, the entire disclosure of which is fully incorporated by reference herein.

### FIELD OF THE INVENTION

The present disclosure relates to pesticidal compositions and to methods for controlling pests, such as insects and other arthropods. More particularly, the disclosure relates to a pesticidal composition that leaves less residue on a treated surface, while providing efficacious control of arthropods, even on food, food contact surfaces, or surfaces adjacent to food contact surfaces.

### BACKGROUND OF THE INVENTION

Insects and other arthropod pests can have negative effects on the quality of human life. For instance, when found in the home, insects and other arthropods can be a source of annoyance due purely to their presence. They may also spread disease and allergens. For example, domestic cockroaches produce allergens in their saliva that may be problematic for people suffering from allergies. It is also desirable to control other crawling arthropods, such as ants, beetles, earwigs, silverfish, crickets, spiders, centipedes and various flying insects including flies, mosquitoes, gnats, moths, wasps, hornets, bees, and the like.

A number of arthropod pest control products exist today to control various arthropod pests, such as roaches, ants, flies, and gnats, both outside and inside the home. And, the market for arthropod pest control products is growing, due to factors such as an increase in urban housing, a growing consumer awareness concerning health and hygiene, and changes in weather patterns. At the same time, there is increasing consumer demand for arthropod pest control products that are natural and can be used on food contact surfaces, for example, in the kitchen. Renewable or sustainable ingredients are also preferred. Consumers also prefer pest control products that contain a limited number of ingredients and/or recognizable ingredients, as communicated by simpler ingredient statements. However, these products are still expected to be efficacious and efficiently kill arthropod pests, comparable to traditional pest control products.

There are existing arthropod pest control products that contain natural ingredients, such as plant essential oils. However, these existing products have a number of disadvantages: some products may be messy to use and/or may leave a residue on a treated surface; some products may be unstable at cold temperatures (i.e., about 5° C. to 10° C.) or separate into multiple phases and require a consumer to vigorously shake the product before use; some products are not recommended for use on food contact surfaces, and some products have limited efficacy. Other products do not provide an optimal scent experience, e.g., emit a long-lasting, unpleasant odor. Still other products do not provide optimal aesthetics, e.g., appear cloudy, or turbid, and/or off color. Therefore, there is a need for effective arthropod pest control compositions that contain fewer and/or natural ingredients, are less messy to use (e.g., reduced residue), can be used on food contact surfaces, provide improved aesthetics, and/or provide an improved scent experience.

### SUMMARY OF THE INVENTION

The present disclosure relates to a pest control composition comprising: a. from about 4% to about 9% by weight of the composition of sodium lauryl sulfate; b. from about 0.3% to about 2% by weight of the composition of a first active ingredient, where the first active ingredient is lemongrass oil; c. from about 3% to about 35% by weight of the composition of isopropyl alcohol; d. from about 65% to about 85% by weight of the composition of water; wherein the composition has a pH of about 3.0 to about 9.0.

The present disclosure also relates to a pest control composition comprising: a. from about 4% to about 9% by weight of the composition of sodium lauryl sulfate; b. from about 0.005% to about 2% by weight of the composition of a first active ingredient, where the first active ingredient is selected from the group consisting of geranial, neral, limonene, geranyl acetate, caryophyllene, and combinations thereof; c. from about 0.005% to about 6% by weight of the composition of a second active ingredient, where the second active ingredient is selected from the group consisting of geraniol, nerol, menthol, menthone, isomenthone, neomenthol, menthyl acetate, pulegone, 1-8-cineole, camphor, alpha-pinene, beta-pinene, and combinations thereof; d. from about 3% to about 35% by weight of the composition of isopropyl alcohol; e. from about 65% to about 85% by weight of the composition of water; wherein the composition has a pH of about 3.0 to about 9.0.

### DETAILED DESCRIPTION OF THE INVENTION

Consumers are looking for effective and natural ways to control a variety of arthropods. However, existing arthropod pest control products that contain natural ingredients are often messy to use, unstable, and/or provide an unpleasant consumer experience, such as by requiring a consumer to shake the product before use and/or by appearing off color. In particular, there is an unmet need for effective arthropod pest control compositions that can be used on or near food contact surfaces, for example, in the kitchen. For many consumers, the kitchen is one of the most popular and most busy areas in the home. The kitchen is where family members gather to make and cat meals. Unfortunately, the kitchen and food stored in the kitchen also attract unwanted pests, such as ants, cockroaches, and fruit flies. Controlling such pests in the kitchen is a both a challenge and a priority for many consumers. There is a need for pest control products that can be used on food, food contact surfaces, or surfaces adjacent to food contact surfaces, e.g., in the kitchen, with less mess (e.g., reduced residue), improved aesthetics, and/or an improved scent, while containing fewer and/or natural ingredients.

Described herein is a substantially clear, substantially colorless, and stable (preferably not requiring shaking before use) aqueous pesticidal composition that is efficacious against arthropod pests. As used herein, “stable” refers to a pesticidal composition that is substantially clear and free from phase separation or precipitation, where no agitation or mixing is required to use the pesticidal composition for its application. The aqueous pesticidal compositions described herein can be used on food contact surfaces, are less messy to use, easy to clean up, and have improved scent and/or aesthetics.

Features and benefits of the various embodiments of the present invention will become apparent from the following description, which includes examples of specific embodiments intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, articles such as “a” and “an” when used in a claim, are understood to mean one or more of what is claimed or described.

As used herein, the terms “include”, “includes” and “including” are meant to be nonlimiting.

The term “renewable” is synonymous with the terms “natural,” “bio-derived”, “bio-based,” and means that a material is derived from substances derived from living organisms, such as farmed plants, rather than, for example, geologically derived, e.g., coal-derived or petroleum-derived.

“Geologically derived” means derived from, for example, petrochemicals, natural gas, or coal. “Geologically derived” materials cannot be easily replenished or regrown (e.g., in contrast to plant- or algae-produced materials).

As used herein, the term “renewable component” refers to a component that is derived from renewable feedstock and contains renewable carbon. A renewable feedstock is a feedstock that is derived from a renewable resource, e.g., plants, and non-geologically derived. A material may be partially renewable (less than 100% renewable carbon content, from about 1% to about 90% renewable carbon content, or from about 1% to about 80% renewable carbon content, or from about 1% to about 60% renewable carbon content, or from about 1% to about 50% renewable carbon content) or 100% renewable (100% renewable carbon content). A renewable feedstock may be blended or chemically reacted with a geologically derived feedstock, resulting in a material with a renewable component and a geologically derived component.

“Renewable carbon” may be assessed using the “Assessment of the Biobased Content of Materials” method, ASTM D6866-16.

As used herein, the term “natural oils” means oils that are derived from plant or algae matter (also referred to as renewable oils). Natural oils are not based on kerosene or other fossil fuels. The term “oils” include fats, fatty acids, waste fats, oils, or mixtures thereof. A natural oil typically includes triglycerides, free fatty acids, or a combination of triglycerides and free fatty acids, and other trace compounds.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.1%, less than about 0.01%, less than about 0.001%, less than about 0.0001%, or less than about 0.00001% by weight of the composition, of the component.

As used herein the term “dye” includes aesthetic dyes that modify the aesthetics of the arthropod pest control composition. Dyes include colorants and pigments.

Volatile Organic Compounds (VOCs) are identified by the U.S. Environmental Protection

Agency (EPA) as organic compounds that participate in atmospheric photochemical reactions, with the exception of compounds that have negligible photochemical reactivity. VOCs are generally emitted as gases from certain solids or liquids. Pesticides may be formulated to contain 40% by weight VOC, or less. The VOC level may be from about 1 wt. % to about 35 wt. %, or from about 2 wt. % to 20 wt. %.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Arthropod Pest Control Composition

The arthropod pest control compositions are preferably in the form of liquids. The arthropod pest control compositions are preferably aqueous compositions. Aqueous liquid compositions are convenient to use because these compositions can be readily applied directly to arthropod pests, without leaving residue on adjacent surfaces. The arthropod pest control composition may comprise from about 40% to about 95%, or from about 50% to about to about 90%, or from about 55% to about 80%, or from about 58% to about 78%, or from about 60% to about 75%, or from about 62% to about 72%, or from about 65% to about 85% by weight of the composition of water. The arthropod pest control compositions may be clear, as clarity may connote purity to the user. The arthropod pest control compositions may be provided in the form of a ready-to-use composition, which can be directly applied to arthropod pests (e.g., as a spray) and need not be diluted by a consumer before use. Ready-to-use compositions may be preferred by some consumers, because ready-to-use compositions do not require dilution by the consumer, which may be messy, inconvenient, and/or require multiple containers. The arthropod pest control compositions disclosed herein may contain select ingredients at select levels suitable to be sprayed directly onto arthropod pests.

The arthropod pest control compositions disclosed herein may be substantially free of geologically derived (e.g., petroleum-based) oils, such as mineral oil. Pest control compositions containing geologically derived oils, such as mineral oil, may also leave a residue on a treated surface and may be generally messy to use.

The pH of the arthropod pest control composition may be from about 3.0 to about 10.0, or from about 3.0 to about 9.0, or from about 3.5 to about 9.5, or from about 4 to about 9.0, or from about 4.5 to about 9.0, or from about 5.0 to about 8.5, or from about 5.5 to about 8. The pH of the composition may be adjusted using pH modifying ingredients known in the art.

The pest control composition may comprise particles having an intensity mean particle size from about 1 nm to about 500 nm, alternatively from about 2 nm to about 250 nm, alternatively from about 3 nm to about 100 nm. Intensity mean intensity particle size can be measured according to the Particle Size Test Method described hereafter.

The pest control composition may comprise particles having a volume mean particle size from about 1 nm to about 500 nm, alternatively from about 2 nm to about 250 nm, alternatively from about 3 nm to about 100 nm. Volume mean intensity particle size can be measured according to the Particle Size Test Method described hereafter.

The pest control composition may comprise particles having a number mean particle size from about 1 nm to about 500 nm, alternatively from about 2 nm to about 250 nm, alternatively from about 3 nm to about 100 nm. Number mean intensity particle size can be measured according to the Particle Size Test Method described hereafter.

The compositions disclosed herein are preferably safe for application to surfaces that come in contact with food, surfaces adjacent to food contact surfaces, or food itself, where there is an increased likelihood that traces of the composition may be ingested. It is desirable for the materials incorporated in the arthropod pest control compositions disclosed herein to be “food compatible” or “food use safe.” Generally, residues from a food compatible or food use safe ingredient may remain on a food contact surface or a food itself, e.g., fruits or vegetables, and are safe for ingestion by humans and/or animals. Food compatible or food use safe ingredients include minimum risk pesticide ingredients listed under section 25(b) of the Federal Insecticide, Fungicide, and Rodenticide Act (FIFRA) and identified, in the list, as “food use” ingredients (products intended for use on food-use sites (e.g., used on food, food crops, food contact surfaces, or animal feed commodities) can only include active ingredients with applicable tolerances or tolerance exemptions).

Food compatible or food use safe ingredients also include ingredients that are suitable for direct or indirect food contact use and/or which can be approved as GRAS, prior sanctioned, or subject to GRAS approval via a GRAS petition, and/or toxicologically acceptable to humans under usage conditions. Materials added to foods (additives) can be categorized as one of several types: (1) direct food additives; (2) indirect food additives; (3) GRAS ingredients (generally recognized as safe) either as direct or indirect food substances; (4) GRAS affirmed, a chemical which may be considered for GRAS classification after experts review adequate technical support data for the GRAS petition; and (5) prior sanctioned, a food ingredient of known food use and granted approval with respect to use of the substance in food prior to September 1958, by the FDA, or USDA.

Food additives include substances that, in use, may become or may reasonably be expected to become, directly or indirectly, a component of the food or may otherwise affect the characteristics of the food. Direct food additives are materials that are added directly to foods to achieve an intended purpose. Indirect food additives are materials that are not directly added to foods but may be mingled or mixed with the food by virtue of close contact with the food. For example, materials that are added to food containers and/or packages, may migrate to and/or mix with the food (stored in the container) due to the close proximity between the container/package and the food. Thus, materials used in the production of food containers and/or packaging materials may be considered indirect food additives.

Indirect food additives may include: (1) adhesives and components of coatings; (2) paper and paperboard components; (3) adjuvants, such as those used in the manufacture of foamed plastics, and sanitizers. Sanitizers used in food applications, as direct or indirect additives, include: (1) aqueous hypochlorite (K, Na or Ca salts); (2) aqueous solutions of dichloroisocyanuric acid, trichloroisocyanuric acid, or the sodium or potassium salts of these acids, either with, or without, the bromides of potassium, sodium, and/or calcium; (3) anionic surfactant solutions, such as dodecylbenzene sulfonic acid, and/or sodium lauryl sulfate; or mixtures of these together or with other anionic surfactants as allowed under FDA regulations; (4) aqueous fatty acid solutions containing decanoic acid, octanoic acid, lactic acid and other ingredients; (5) aqueous solutions comprised of hydrogen peroxide, peroxyacetic acid, acetic acid, sulfuric acid and other ingredients as allowed by FDA regulations: (6) quaternary sanitizers, such as di-n-alkyl (C8-10) dimethylammonium chloride and n-alkyl (C12-16) benzyl-dimethylammonium chloride; (7) aqueous solutions containing ortho-phenylphenol. ortho-benzyl-para-chlorophenol, para-tertiaryamylphenol and/or other ingredients as allowed under FDA regulations.

Ingredients added directly or indirectly to food can be affirmed as generally recognized as safe (GRAS). The GRAS ingredient may include any agent listed on the FDA's GRAS list, including direct food additives (see, e.g., US law (sections 201 (s) and 409 of the Federal Food, Drug, and Cosmetic Act, November 2016). The GRAS ingredient may also include, but is not limited to, agents that are generally recognized, among experts qualified by scientific training and experience to evaluate their safety, as having been adequately shown through scientific procedures (or, in the case of a substance used in food prior to Jan. 1, 1958, through either scientific procedures or through experience based on common use in food) to be safe.

The compositions disclosed herein may comprise at least one ingredient that is food compatible or food use safe, such as food grade ingredients or generally recognized as safe (GRAS) ingredients. Compositions comprising food compatible or food use safe ingredients may be used by consumers without rinsing or wiping a treated surface or treated food, e.g., fruits or vegetables, after use. The compositions disclosed herein may comprise ingredients that have a tolerance or tolerance exemption for use on food contact surfaces under the Federal Food, Drug, and Cosmetic Act US law (see, e.g., 40 CFR 180, November 2016, December 2015 update).

Direct GRAS ingredients may be used under current good manufacturing practice (GMP), which may require that a direct food additive is food grade, is prepared and handled as a food ingredient, and is added at an appropriate concentration (e.g., not exceeding the concentration that is reasonably required to accomplish an intended physical, nutritional, or other technical effect in the food). Indirect GRAS ingredients may also be used under current good manufacturing practice (GMP), which may require that an indirect food additive be of an appropriate purity and that the quantity of the indirect additive (e.g., added to food container, packaging, wrapper) not exceed the concentration that is reasonably required to accomplish an intended physical, nutritional, or other technical effect in the food container.

The pest control compositions disclosed herein may comprise ingredients eligible for minimum risk pesticide products listed under section 25(b) of the Federal Insecticide, Fungicide, and Rodenticide Act (FIFRA) (also referred to as FIFRA 25(b) exempt pesticides), incorporated herein by reference in its entirety. The compositions disclosed herein may comprise naturally occurring compounds or extracts or derivatives thereof. The compositions disclosed herein may comprise at least one organic, certified organic, US Department of Agriculture (“USDA”) National Organic Program compliant (“NOP-compliant”) ingredient.

The compositions disclosed herein may comprise less than about 15 ingredients, preferably less than about 10 ingredients, more preferably less than about 15 ingredients and greater than about 5 ingredients.

The arthropod pest control compositions disclosed herein may have a relatively high level of clarity (i.e., low turbidity). Some consumers prefer a clear product versus a product that is cloudy or murky (i.e., higher turbidity). The compositions may exhibit a turbidity of less than about 20 NTU, preferably less than about 5 NTU, and greater than or equal to about 0 NTU. The compositions may exhibit a turbidity of from about 1 to about 10 NTU. Turbidity of the compositions is measured with a laboratory turbidity meter as described in the Test Methods section below.

The arthropod pest control compositions disclosed herein may have a reduced yellow color. Some consumers prefer a colorless or substantially colorless product versus a product that has a yellow color. Yellow color may be characteristic of the breakdown of certain active ingredients in the compositions, particularly the breakdown of plant oils, such as cornmint oil and rosemary oil. The reduction of the yellow color may be measured by any colorimetric or spectrometric method known in the art. Suitable colorimetric analytical methods include, for example, the Gardner color scale (according to American Society for Testing and Materials (“ASTM”) method ASTM D1544, D6166 and/or American Oil Chemists' Society (“AOCS”) method AOCS Td-la-64); the CIELAB color scale (according to ASTM D5386-93b); the American Public Health Association (“APHA”) color scale (according to ASTM D1209 or AOCS Td-1b-64); the Saybolt color scale (according to ASTM D156 or D6045); or the Lovibond (red) scale (according to AOCS Cc-13b-45). The CIELAB color scale may be used to quantify the color of an arthropod pest control composition. The CIELAB color scale may also be referred to as L*a*b*, a color scale defined by the International Commission on Illumination (abbreviated CIE) in 1976. The CIELAB color scale expresses color as three values: L* for perceptual lightness, and a* and b* for the four unique colors of human vision: red, green, blue, and yellow, where the b* value represents blue/yellow color. It should be noted that the present disclosure is not limited to any specific colorimetric measurement and the reduction of the yellow color observed may be measured by any suitable colorimetric method.

The arthropod pest control compositions of the present disclosure may comprise renewable components and exhibit good efficacy against arthropod pests. The compositions disclosed herein may comprise from about 1%, or from about 5%, or from about 10%, or from about 20% or from about 30%, or from about 40% or from about 50%, to about 40%, or to about 50%, or to about 60% or to about 70%, or to about 80%, or to about 90%, or to about 100%, by weight of renewable components. The compositions disclosed herein may be at least partially or fully bio-based. As such, the composition can comprise a bio-based carbon content of about 50% to about 100%, preferably about 70% to about 100%, more preferably about 75% to about 100%, even more preferably about 80% to about 100%, most preferably about 90% to about 100%. The percent bio-based carbon content can be calculated as the “percent Modern Carbon (pMC)” as derived using the methodology of ASTM D6866-16. The compositions of the present disclosure may be substantially free of petroleum-derived solvents or petroleum-derived surfactants.

The compositions disclosed herein may contain less than or equal to about 40% by weight VOCs, or less than or equal to about 25% by weight VOCs, or less than or equal to about 20% by weight VOCs, or less than or equal to about 15% by weight VOCs, or less than or equal to about 10% by weight VOCs. The VOC level may be from about 1 wt. % to about 35 wt. %, or from about 2 wt. % to 20 wt. %.

### Active Ingredients

The arthropod pest control composition may comprise one or more active ingredients (also referred to herein as actives). The arthropod pest control composition may comprise from about 0.005% to about 15%, or from about 0.05% to about 15%, or from about 0.15% to about 15%, or from about 0.5% to about 15%, or from about 1% to about 15%, or from about 1% to about 10%, by weight of the composition, of one or more active ingredients.

Nonlimiting examples of active ingredients include aldehyde C16 (pure), almond oil, terpenes, alpha-terpineol, verbenone, alpha-cedrene, cinnamic aldehyde, amyl cinnamic aldehyde, cinnamyl acetate, amyl salicylate, anisic aldehyde, citric acid, cedrol, benzyl alcohol, benzyl acetate, cinnamaldehyde, cinnamic alcohol, carvacrol, caryophyllene, carveol, citral, citronellal, methylheptenone, citronellol, dimethyl salicylate, cucalyptol (also known as 1,8-cincole), thujopsene, 3-thujopsanone, α-thujone, β-thujone, fenchone, eugenyl acetate (e.g., isoeugenyl acetate), eugenol, iso-eugenol, methyl iso-eugenol, galaxolide, geraniol, guaiadiene, guaiacol, ionone, menthol (e.g., L-menthol), menthyl ester, menthone, carvone (e.g., L-carvone), camphor, camphene, p-cymene, borneol, bornyl esters, bornyl acetate, isobornyl acetate, terpinene (e.g., gamma-terpinene), methyl anthranilate, methyl ionone, methyl salicylate, nerol, phellandrene (e.g., alpha-phellandrene), pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, myrcene, chavicol, acetaldehyde, safrole, terpinen-4-ol, cineole, dimethyl trisulfide, diallyl disulfide, diallyl sulfide, diallyl tetrasulfide, 3-vinyl-[4H]-1,2-dithiin, thyme oil, thyme oil white, thyme oil red, thymol, anethole (e.g., trans-anethole), vanillin, ethyl vanillin, castor oil, cedar oil, cedarwood oil, cinnamon, cinnamon oil, citronella, citronella oil, clove, clove oil, corn oil, corn mint oil, oregano oil, cottonseed oil, garlic, garlic oil, geranium oil, lemongrass oil, linseed oil, mint, mint oil, peppermint, peppermint oil, spearmint, rose oil, spearmint oil, rosemary, rosemary oil, sesame, sesame oil, soybean oil, white pepper, licorice oil, wintergreen oil, anise oil (e.g., star anise oil), lilac flower oil, black seed oil, bay oil, grapefruit seed oil, grapefruit, lemon oil, orange oil, orange flower oil, tea tree oil, cedar leaf oil, camphor oil, Tagete minuta oil, lavender oil, Lippia javanica oil, oil of bergamot, galbanum oil, eucalyptus oil, lovage oil, and mixtures thereof.

The arthropod pest control composition may comprise about 0.005% to about 15%, preferably from about 0.05% to about 15%, more preferably from about 0.15% to about 12%, even more preferably from about 0.5% to about 10%, by weight of the composition, of one or more active ingredients selected from the group consisting of eugenol, 2-phenylethyl propionate, menthol, menthone, amyl butyrate, geraniol, limonene (e.g., d-limonene), p-cymene, linalool, linalyl acetate, camphor, methyl salicylate, pinene (e.g., alpha-pinene, beta-pinene), cucalyptol, piperonal, piperonyl alcohol, tetrahydrolinalool, thymol, carvone (e.g., L-carvone), vanillin, ethyl vanillin, iso-eugenol, bornyl acetate, isobornyl acetate, terpinene (e.g., gamma-terpinene), cinnamyl acetate, cinnamic alcohol, cinnamaldehyde, ethyl cinnamate, pyrethrins, abamectin, azadirachtin, amitraz, rotenone, boric acid, spinosad, biopesticides, synthetic pesticides, and mixtures thereof.

The arthropod pest control composition may comprise one or more synthetic pesticides. Nonlimiting examples of synthetic pesticides include pyrethroids, such as bifenthrin, esfenvalerate, fenpropathrin, permethrin, cypermethrin, cyfluthrin, deltamethrin, allethrin, lambda-cyhalothrin, or the like; synergists, such as piperonyl butoxide, or the like; juvenile hormone analogues, such as methoprene, hydroprene, kinoprene, or the like; and neonicotinoids, such as imidacloprid, acetamiprid, thiamethoxam, or the like, and mixtures thereof. The arthropod pest control composition may comprise less than about 10%, or less than about 5%, or less than about 2%, or less than about 1%, or less than about 0.5%, or less than about 0.1% by weight synthetic pesticide. Alternatively, the arthropod pest control composition may be substantially free of a synthetic pesticide.

The arthropod pest control composition may comprise one or more biopesticides. Nonlimiting examples of biopesticides include pyrethrum, rotenone, neem oil, and mixtures thereof.

The arthropod pest control composition may comprise from about 0.15% to about 15%, or from about 0.5% to about 15%, or from about 0.5% to about 15%, or from about 0.5% to about 10%, by weight of the composition, of one or more active ingredients, where the active ingredient is an essential plant oil or a constituent thereof. The arthropod pest control composition may comprise one or more essential plant oils or constituents thereof selected from the group consisting of corn mint oil, peppermint oil, spearmint oil, rosemary oil, thyme oil, citronella oil, clove oil, cinnamon oil, cedarwood oil, garlic oil, geranium oil, geraniol, lemongrass oil, and mixtures thereof, preferably selected from the group consisting of corn mint oil, geraniol, spearmint oil, rosemary oil, lemongrass oil, thyme oil, and mixtures thereof, more preferably selected from the group consisting of corn mint oil, geraniol, lemongrass oil, and combinations thereof. The arthropod pest control composition may comprise from about 0.3% to about 1.2% by weight of the composition of a first active ingredient, where the first active ingredient is lemongrass oil. The arthropod pest control composition may comprise from about 1% to about 6%, or from about 2% to about 6%, by weight of the composition, of a second active ingredient selected from the group consisting of corn mint oil, geraniol, and combinations thereof.

### Carboxylic Acid or Salt Thereof

The arthropod pest control compositions described herein may comprise from about 0.00001% to about 1.5%, preferably from about 0.0001% to about 1%, more preferably from about 0.001% to about 0.8%, even more preferably from about 0.01% to about 0.6%, by weight of the composition of a carboxylic acid selected from the group consisting of citric acid or a salt thereof, malic acid or a salt thereof, acetic acid or a salt thereof, fumaric acid or a salt thereof, humic acid or a salt thereof, and mixtures thereof, preferably citric acid or a salt thereof, more preferably citric acid anhydrous or citric acid monohydrate. The compositions described herein may comprise from about 0.00001% to about 1.5% by weight of the composition of citric acid or a salt thereof, such as sodium citrate, monosodium citrate, disodium citrate, trisodium citrate, trisodium citrate dihydrate, potassium citrate, monopotassium citrate, tripotassium citrate, tripotassium citrate monohydrate, or dipotassium citrate. Carboxylic acids, such as citric acid, or salts thereof may function to adjust the pH of the composition and/or as a chelant.

### Surfactant

The arthropod pest control composition disclosed herein may be formulated with one or more surfactants. The pest control composition may comprise from about 0.01% to about 15%, or from about 0.1% to about 10%, or from about 1% to about 10%, or from about 1% to about 8%, or from about 4% to about 9%, by weight of the composition, of one or more surfactants, preferably one or more anionic surfactants, more preferably sodium lauryl sulfate.

A sprayed drop of a pesticidal composition comprising an active agent is preferably able to wet a target surface and spread out or cover a target area to perform its intended function. A surfactant generally reduces the surface tension of the water on the surface of the spray drop by reducing the interfacial tension between the spray drop and target surface, e.g., exoskeleton of an arthropod. Surfactants also wet and disperse particles of active ingredient(s) in the composition prior to spraying, thereby enabling more uniform coverage and wetting of the target arthropod upon spraying. Surfactants may also function to emulsify active agents that are not easily solubilized in water, such as oils. Surfactants thus include various agents known to function as emulsifiers or wetting agents. Suitable surfactants include anionic surfactants, amphoteric surfactants, zwitterionic surfactants, nonionic surfactants, cationic surfactants, or mixtures thereof.

Anionic surfactants are surfactant compounds that contain a long chain hydrocarbon hydrophobic group in their molecular structure and a hydrophilic group, including salts such as carboxylate, sulfonate, sulfate or phosphate groups. The salts may be sodium, potassium, calcium, magnesium, barium, iron, ammonium and amine salts of such surfactants. Anionic surfactants include the alkali metal, ammonium and alkanol ammonium salts of organic sulfuric reaction products having in their molecular structure an alkyl or alkaryl group containing from about 8 to about 22 carbon atoms and a sulfonic or sulfuric acid ester group. Examples of such anionic surfactants include water soluble salts and mixtures of salts of alkyl benzene sulfonates having from about 8 to about 22 carbon atoms in the allyl group (e.g., linear alkyl benzene sulfonates, such as dodecylbenzene sulfonate and salts thereof), alkyl sulfates and alkali metal salts thereof (preferably those having from about 8 to about 22 carbon atoms in the alkyl group, e.g., sodium dodecyl/lauryl sulfate), alkyl ether sulfates having from about 8 to about 22 carbon atoms in the alkyl group and about 2 to about 9 moles of ethylene oxide. Aryl groups generally include one or two rings, alkyl groups generally include from about 8 to about 22 carbon atoms, and ether groups generally comprise from about 1 to about 9 moles of ethylene oxide (EO) and/or propylene oxide (PO), preferably EO. A preferred anionic surfactant is sodium lauryl sulfate or SLS (also known as sodium dodecyl sulfate). The pest control composition may comprise from about 1% to about 10%, preferably from about 2% to about 8.5%, more preferably from about 4% to about 9%, or from about 4% to about 8%, by weight of the composition, of sodium lauryl sulfate.

Anionic surfactants also include fatty acids and salts thereof. Fatty acids and salts thereof are organic molecules comprising a single carboxylic acid moiety (carboxylate anion in salts) and at least 7 carbon atoms, or from about 11 to about 22 carbon atoms, or from about 12 to about 16 carbon atoms. The salts may be sodium, potassium, calcium, magnesium, barium, iron, ammonium and amine salts of fatty acids. The salts of fatty acids are also known as soaps. Fatty acid and the salts thereof may be linear, branched, saturated, unsaturated, cyclic, or mixtures thereof.

Nonlimiting examples of fatty acids and salts thereof include octanoic acid, nonanoic acid, decanoic acid, lauric acid, myristic acid, palmitic acid, stearic acid, arachidic acid, behenic acid, lignoceric acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, docosahexaenoic acid, the sodium, calcium, potassium or zinc salts thereof, or mixtures thereof.

Alternatively, the compositions may be substantially free of fatty acids, as a fatty acid may be difficult to solubilize in an aqueous composition. In particular, the compositions may be substantially free of lauric acid, oleic acid, stearic acid, or a combination thereof.

Additional suitable anionic surfactants include alkyl sulfosuccinates, alkyl ether sulfosuccinates, olefin sulfonates, alkyl sarcosinates, alkyl monoglyceride sulfates and ether sulfates, alkyl ether carboxylates, paraffinic sulfonates, acyl methyl taurates, sulfoacetates, acyl lactates, and sulfosuccinamides.

Amphoteric surfactants are surface active agents containing at least one anionic group and at least one cationic group and may act as either acids or bases, depending on pH. Some of these compounds are aliphatic derivatives of heterocyclic secondary and tertiary amines, in which the aliphatic substituent(s) may be straight or branched, at least one of the aliphatic substituents contains from about 6 to about 20, or from about 8 to about 18, carbon atoms, and at least one of the aliphatic substituents contains an anionic water-solubilizing group, e.g., carboxy, phosphonate, phosphate, sulfonate, sulfate.

Zwitterionic surfactants are surface active agents having a positive and negative charge in the same molecule, where the molecule is zwitterionic at all pHs. Zwitterionic surfactants include betaines and sultaines. The zwitterionic surfactants generally contain a quaternary ammonium, quaternary phosphonium, or a tertiary sulfonium moiety. Zwitterionic surfactants contain at least one straight chain or branched aliphatic substituent, which contains from about 6 to 20, or from about 8 to about 18, carbon atoms, and at least one aliphatic substituent containing an anionic water-solubilizing group, e.g., carboxy, sulfonate, sulfate, phosphate or phosphonate.

Examples of suitable amphoteric and zwitterionic surfactants include the alkali metal, alkaline earth metal, ammonium or substituted ammonium salts of alkyl amphocarboxyglycinates and alkyl amphocarboxypropionates, alkyl amphodipropionates, alkyl monoacetate, alkyl diacetates, alkyl amphoglycinates, and alkyl amphopropionates, where the alkyl group has from 6 to about 20 carbon atoms. Other suitable amphoteric and zwitterionic surfactants include alkyliminomonoacetates, alkyliminidiacetates, alkyliminopropionates, alkyliminidipropionates, and alkylamphopropylsulfonates, where the alkyl group has from about 12 to about 18 carbon atoms, as well as alkyl betaines, alkylamidoalkylene betaines, alklyl sultaines, and alkylamidoalkylenchydroxy sulfonates.

The nonionic surfactant(s) may be any of the known nonionic surfactants, examples of which include condensates of ethylene oxide with a hydrophobic moiety. Nonionic surfactants include ethoxylated primary or secondary aliphatic alcohols having from about 8 to about 24 carbon atoms, in either straight or branch chain configuration, with from about 2 to about 40, or from about 2 and about 9 moles of ethylene oxide per mole of alcohol. Other suitable nonionic surfactants include the condensation products of alkyl phenols having from about 6 to about 12 carbon atoms with about 3 to about 100, or 3 to about 60, or 3 to about 30, or about 5 to about 14 moles of ethylene oxide. Nonionic surfactants also include ethoxylated castor oils and silicone surfactants, such as Silwet L-8610, Silwet L-8600, Silwet L-77, Silwet L-7657, Silwet L-7650, Silwet L-7607, Silwet L-7604, Silwet L-7600, and Silwet L-7280.

The arthropod pest control compositions of the present disclosure may optionally comprise one or more cationic surfactants. Suitable cationic surfactants include quaternary ammonium surfactants and amino surfactants that are positively charged at the pH of the arthropod pest control composition.

The weight ratio of surfactant, preferably anionic surfactant, more preferably sodium lauryl sulfate, to active ingredient is from about 1:3 to about 30:1, or about 1:3 to about 20:1, or about 1:1 to about 20:1, or about 1:1 to about 10:1, or about 1:3 to about 3:1, or about 1:2 to about 2:1, or about 1:1.5 to about 1.5:1, or about 1:1.2 to about 1.2:1. The weight ratio of surfactant, preferably anionic surfactant, more preferably sodium lauryl sulfate, to lemongrass oil may be about 1:1 to about 30:1 or about 2:1 to about 30:1. The weight ratio of surfactant, preferably anionic surfactant, more preferably sodium lauryl sulfate, to active ingredient, preferably an essential oil or a constituent thereof, may be from about 1:1 to about 30:1 or about 1:1 to about 20:1.

### Solvent

The arthropod pest control compositions described herein may comprise from about 1% to about 45%, or from about 1% to about 30%, or from about 1% to about 25%, or from about 1% to about 15%, or from about 8% to about 20% by weight the composition of one or more solvents. Liquid arthropod pest control compositions may contain one or more solvents and water.

Suitable solvents include alcohols, such as monohydridic or polyhydric alcohols. Preferred alcohols are low molecular weight primary or secondary alcohols exemplified by ethanol, propanol, and isopropanol, preferably isopropanol. Monohydric alcohols and polyols, such as those containing from 2 to about 6 carbon atoms and from 2 to about 6 hydroxy groups (e.g., ethylene glycol, glycerine, and 1,2-propanediol (also referred to as propylene glycol)), may also be used.

Suitable solvents also include esters. The arthropod pest control composition may comprise from about 0.005% to about 15%, or from about 0.05% to about 12%, or from about 0.5% to about 10%, or from about 1% to about 7%, by weight of the composition, of one or more esters. Esters are commonly formed by reacting a carboxylic acid with a molecule comprising one or more hydroxyl groups. Examples of suitable carboxylic acids include acetic acid, formic acid, lactic acid, citric acid, malic acid, oxalic acid, propanoic acid, propiolic acid, butyric acid, isobutyric acid, caproic acid, adipic acid, benzoic acid, salicylic acid, caprylic acid and fatty acids. Nonlimiting examples of molecules comprising one or more hydroxyl groups include methanol, ethanol, sorbitol, propyl alcohol, isopropyl alcohol, butyl alcohol, sec-butyl alcohol, isobutyl alcohol, tert-butyl alcohol, ethylene glycol, propylene glycol, glycerol, polyglycerol, cyclohexanol, and benzyl alcohol. Examples of suitable esters include isopropyl myristate, myristyl myristate, isopropyl palmitate, octyl palmitate, isopropyl isothermal, butyl lactate, ethyl lactate, butyl stearate, triethyl citrate, glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, decyl oleate, glyceryl stearate, isocetyl stearate, octyl stearate, putty stearate, isostearyl neopentanoate, PPG myristyl propionate, diglyceryl monooleate, and diglyceryl monostearate. The arthropod pest control composition may comprise ethyl lactate, preferably from about 0.005% to about 15%, or from about 0.05% to about 12%, or from about 0.5% to about 10%, or from about 1% to about 7%, by weight of the composition, of ethyl lactate.

Additional solvents include lipophilic fluids, including siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, and mixtures thereof.

Suitable solvents listed under section 25(b) of the Federal Insecticide, Fungicide, and Rodenticide Act (FIFRA) include butyl lactate (including enantiomers thereof), vinegar, 1,2-propylene carbonate, isopropyl myristate, ethyl lactate (including enantiomers thereof), and glycerine.

Preferred solvents include isopropanol, ethanol, glycerine, ethyl lactate, renewable versions thereof, and mixtures thereof. The arthropod pest control compositions described herein may comprise from about 1% to about 45%, or from about 1% to about 30%, or from about 1% to about 25%, or from about 1% to about 15%, by weight the composition, of a solvent selected from the group consisting of isopropanol, glycerine, and mixtures thereof. The arthropod pest control compositions described herein may comprise from about 8% to about 20%, by weight the composition, of isopropanol. The arthropod pest control compositions described herein may comprise from about 0.3% to about 5%, preferably from about 0.3% to about 3%, by weight the composition, of glycerine.

### Bicarbonate

The arthropod pest control composition may comprise bicarbonate, preferably a bicarbonate inorganic salt, more preferably sodium bicarbonate. The arthropod pest control composition may comprise from about 0.01% to about 15%, preferably about 0.1% to about 8%, more preferably about 0.4% to about 4%, by weight of the composition, of a bicarbonate, preferably sodium bicarbonate.

### Polysaccharide Gums

The arthropod pest control compositions disclosed herein may comprise a polysaccharide gum. Suitable polysaccharide gums include xanthan gum, guar gum, gum arabic, cellulose, and cellulose derivatives. The arthropod pest control compositions disclosed herein may comprise xanthan gum. The arthropod pest control compositions of the present disclosure may comprise from about 0.1% to about 7.5%, or from about 0.5% to about 4.5%, or from about 0.1% to about 2.3%, by weight of the composition, of a polysaccharide gum, preferably xanthan gum.

### Preservatives

The arthropod pest control compositions disclosed herein may comprise one or more preservatives. As used herein a “preservative” is any substance or compound that is added to protect against decay, decomposition, or spoilage. Preservatives may be natural or synthetic. Preservatives may be antimicrobial preservatives, which inhibit the growth of bacteria or fungi, including mold, or antioxidants. Nonlimiting examples of preservatives include potassium sorbate, sodium benzoate, tocopherol (e.g., tocopherol acetate), calcium propionate, sodium nitrate, sodium nitrite, sulfites (sulfur dioxide, sodium bisulfite, potassium hydrogen sulfite, etc.), and disodium EDTA. The arthropod pest control compositions disclosed herein may comprise from about 0.02% to about 4%, by weight of the composition, of a preservative, preferably a preservative selected from the group consisting of potassium sorbate, tocopherol, and mixtures thereof.

### Dye

The arthropod pest control composition may comprise a dye or colorant. Nonlimiting examples of colorants include inorganic pigments, such as ultramarine blue, organic dyes, and trace nutrients, such as salts of iron, manganese, boron, copper, cobalt, molybdenum and zinc. Colorants may be included to modify the aesthetics of the arthropod pest control compositions. The compositions disclosed herein may comprise from about 0.001% to about 0.1%, preferably 0.005% to about 0.05%, more preferably 0.008% to about 0.02%, by weight of the composition, of a dye or colorant. Alternatively, the arthropod pest control composition may be substantially free of a colorant.

### Packaging and Dispensing

The arthropod pest control compositions described herein may be packaged in any suitable container, including those constructed from paper, cardboard, plastic materials, and any suitable laminates, and the compositions may be dispensed in any number of suitable manners, such as spraying, e.g., pump-spray, trigger-spray, and the like.

The arthropod pest control compositions described herein may be packaged in a transparent or translucent container or bottle. The transparent or translucent bottle may have a light transmittance of greater than 25% at wavelength of about 410-800 nm. Bottle materials that may be used include, but are not limited to: polypropylene (PP), polyethylene (PE), polycarbonate (PC), polyamides (PA) and/or polyethylene terephthalate (PETE), polyvinylchloride (PVC); and polystyrene (PS).

The transparent bottle or container may have a transmittance of more than about 25%, or more than about 30%, or more than about 40%, or more than about 50% in the visible part of the spectrum (approx. 410-800 nm). Alternatively, absorbency of the bottle may be measured as less than about 0.6 or by having transmittance greater than about 25%, where % transmittance equals:

$$\frac{1}{{10}^{absorbency}} \times 100 \%$$

For purposes of the disclosure, as long as one wavelength in the visible light range has greater than about 25% transmittance, it is considered to be transparent/translucent.

### Method of Controlling an Arthropod Pest

The pest control compositions described herein are particularly suited for controlling arthropod pests on or near food contact surfaces, particularly food contact surfaces in the kitchen, e.g., on, in, under, or near counter-tops and floors, appliances (such as the refrigerator), cookware (such as teapots, pots, and pans), tableware (e.g., plates), utensils, soft surfaces (such as tablecloths, placemats, and oven mitts). The pest control compositions described herein may be used on or near hard surfaces commonly found in kitchens, such as ceramic tiles, enamel, stainless steel, Inox®, Formica®, vinyl, no-wax vinyl, linoleum, melamine, glass, plastics, and plastified wood. The pest control compositions may also provide a cleaning benefit on such hard surfaces, due primarily to the presence of sodium lauryl sulfate in the composition. The pest control compositions described herein may even be used directly on food, optionally with a subsequent rinse step.

A method of controlling a pest on or near food or a food contact surface may comprise: i) contacting the arthropod pest on or near food or a food contact surface with a pest control composition(s) as described herein; ii) optionally wiping and/or rinsing (e.g., with water) the food or a food contact surface, preferably to clean the food contact surface. As discussed above, wiping the food contact surface may provide a cleaning benefit on the surface, due to the presence of sodium lauryl sulfate in the composition. Optionally, the food or a food contact surface may be left to dry, without wiping or rinsing.

### Test Methods

### Particle Size Test Method

Particle size is measured by light scattering data techniques. Particle size is determined with a Malvern Zetasizer Nano ZSP (Malvern Panalytical, Malvern, United Kingdom), or the like. The software used for control of the instrument and for data acquisition is the Malvern Zetasizer Software version 8.01.4906 (Malvern Panalytical). All samples are kept at 25° C., unless otherwise specified.

Samples are measured in BRAND® polystyrene disposable cuvettes (Cat. No. 759070D or equivalent). 1 mL of the sample is added into the cuvette using a disposable transfer pipette (VWR, Cat. No. 414004-004 or equivalent), swirled, and then discarded. Another 1 mL of the sample is added into the cuvette using a disposable transfer pipette. The cap is placed on the cuvette and all sides of the cuvette are wiped with lint-free lens paper. The cuvette is loaded into the instrument in accordance with the manufacture's specification to ensure light is passing correctly into the sample during the measurement, and the lid is closed.

The instrument is readied in accordance with manufacture's specification. The particle size measurements are made through the software with the following settings:

1) Under the ‘Measure’ section, the ‘Manual’ option is selected. ‘Measurement Type’ is then set to ‘Size’.

2) The ‘Sample’ section is then selected. In the ‘Material’ subsection: ‘Material’ is chosen to be ‘SDS’; the ‘RI’ is set to 1.461; and the ‘Absorption’ is set to 0.001. In the ‘Dispersant’ subsection: ‘Dispersant’ is selected as ‘Water’; ‘Temperature’ is set to 25.0 deg C.; ‘Viscosity’ is set at 0.8872 cP; and ‘RI’ is set as 1.330. In the ‘General options’ subsection ‘Mark-Houwink Parameters’ is selected, ‘A Parameter’ is set to 0.428; and ‘K Parameter (cm2/s)’ is set to 7.67e−05. In the ‘Temperature’ subsection: ‘Temperature’ is set as 25.0 deg C.; ‘Equilibration Time (second)’ is set to 120. In the ‘Cell’ subsection: ‘Cell Type’ is selected to be ‘Disposable cuvettes’; and the ‘DTS0012’ option is selected.

3) The ‘Measurement’ section is then selected. The ‘Angle of Detection Measurement Angle’ is selected as ‘1730 Backscatter (NIBS default)’; ‘Measurement Duration’ is selected as ‘Automatic’; ‘Number of Runs’ is set to 11; ‘Run duration (seconds)’ is set to 10; ‘Number of Measurements’ is set as 3; ‘Delay between Measurements (seconds)’ is set to 0; ‘Append Measurement Number to Sample Name’ is selected; and ‘Allow Results to be Saved Containing Correlation Data Only’ is not selected. In the ‘Advanced’ subsection: ‘Measurement duration, Extend Duration for Large Part’ is set to ‘No’; ‘Measurement settings, Positioning method’ is set to ‘Seek for Optimum Position’; and Automatic attenuation selection is set to ‘Yes’.

4) The ‘Data Processing’ section is then selected, and the following options are selected: ‘Analysis Model’ is selected as ‘General Purpose (Normal Resolution)’. The ‘Size Analysis Parameters’ are set to: ‘Analysis Details’; ‘Name’ is set to ‘Customized’, ‘Description’ is set to ‘Customized Analysis’; ‘Display Range’ is set with the ‘Lower Limit’ set to 0.6 and ‘Upper Limit’ set to 6000; ‘Multimodal-analysis, Resolution’ is selected to ‘Normal’; ‘Size classes, Number of size classes’ is set as 70; ‘Lower Size Limit’ is set as 0.4; ‘Upper Size Limit’ is set as 10,000; ‘Lower Threshold’ is set as 0.05; and ‘Upper Threshold’ is set as 0.01. In the ‘Reports’ subsection: ‘Print Report’ is not selected and in the ‘Export’ subsection: ‘Export’ results is not selected.

### Determination of the Hunter L.a.b. (CIE) b* Value

The formation of yellow color is measured using the Hunter L.a.b. (CIE) method. The b value is determined using a HunterLab ColorFlex EZ® spectrophotometer (HunterLab, 11491 Sunset Hills Road, Reston, Virginia 20190). The methodology that is used is described in detail in the “User's Manual for ColorFlex EZ Version 2.2.” The average of four separate readings is reported.

The HunterLab ColorFlex EZ® spectrophotometer uses a xenon flash lamp to illuminate a sample. The light reflected from the sample is then separated into its component wavelengths through a dispersion grating. The relative intensities of the light at different wavelengths along the visible spectrum (400-700 nm) are then analyzed to produce a number result indicative of the color of the sample.

### Turbidity

A turbidimeter is used to measure the turbidity of pesticidal compositions. This instrument measures the turbidity of liquids in Nephelometric Turbidity Units (NTU). The method of measuring turbidity is described in detail in the following reference: Hach 2100Q and 2100Qis User Manual, Edition 6, 08/2021, from the Hach Company.

This method of measurement determines quantitative values of turbidity by evaluating the ratio of a primary nephelometric light scatter signal to a transmitted light scatter signal. This particular method of evaluation provides values between 0-1000 NTU, where increasing NTU values indicate more turbid compositions. In between each test sample, water controls may be measured to ensure proper equipment operation. For example, water may have a turbidity of about 1.11 NTU and isopropyl alcohol may have a turbidity of about 0.15 NTU. It is believed that improved emulsification of active ingredients, particularly hydrophobic active ingredients, yields lower NTU values.

### Stability

Sample formulations are placed in suitable containers, such as sealed glass jars, and stored at 25° C. for 24 hours and subsequently assessed visually for number of phases. A stable formulation contains a single phase.

### EXAMPLES

### Example I—Effect of Lemongrass Oil Concentration on Color at Various pHs

Some consumers may prefer a colorless or substantially colorless pesticidal composition, without accepting any compromises on the effectiveness of the composition. Pesticidal compositions A through H, in Table I, vary in the concentration lemongrass oil. Pesticidal compositions C, I, and J, in Table II, vary in pH, among other things.

The results in Table I show that the concentration of lemongrass oil affects color and the results in Table II show that the pH of the composition affects color. Formulations A, B, C, and D are substantially colorless, exhibiting b* values of 0.79, 1.67, 2.81, and 4.04, respectively.

Formulations A through F are also tested for turbidity and each has a turbidity less than 20 NTU. A formulation perceived by a user to be clear generally has a NTU less than 20, while a turbid formulation has a NTU greater than 20.

TABLE I

| Ingredient | | | | | | | | |
|---|---|---|---|---|---|---|---|---|
| (weight | | | | | | | | |
| percent) | A | B | C | D | E | F | G | H |
| Water | QS | QS | QS | QS | QS | QS | QS | QS |
| Sodium Citrate | 0.92 | 0.92 | 0.92 | 0.92 | 0.92 | 0.92 | 0.92 | 0.92 |
| Sodium Lauryl | 6 | 6 | 6 | 6 | 6 | 8.5 | 8.5 | 8.5 |
| Sulfate | | | | | | | | |
| Lemongrass | 0.3 | 0.4 | 0.4 | 0.75 | 1.0 | 1.0 | 2.0 | 3.0 |
| Oil | | | | | | | | |
| Cornmint Oil | 0 | 0 | 2.0 | 0 | 0 | 0 | 0 | 0 |
| Geraniol | 0 | 0 | 2.5 | 0 | 0 | 0 | 0 | 0 |
| Isopropyl | 11.6 | 11.6 | 11.6 | 11.6 | 11.6 | 19.0 | 19.0 | 19.0 |
| Alcohol | | | | | | | | |
| Glycerin | 0.5 | 0.5 | 0.5 | 0.5 | 0.5 | 0.5 | 0.5 | 0.5 |
| Citric acid | 0.06 | 0.06 | 0.06 | 0.06 | 0.06 | 0.06 | 0.06 | 0.06 |
| Color | 0.8 | 1.7 | 1.1 | 2.8 | 4.0 | 2.6 | 4.3 | 5.5 |
| (b* value) | | | | | | | | |

TABLE II

| Ingredient (weight | | | |
|---|---|---|---|
| percent) | C | I | J |
| Water | QS | QS | QS |
| Sodium Citrate | 0.92 | 0.92 | 0.92 |
| Sodium Lauryl Sulfate | 6 | 8.5 | 8.5 |
| Lemongrass Oil | 0.4 | 1.0 | 1.0 |
| Cornmint Oil | 2.0 | 0 | 0 |
| Geraniol | 2.5 | 0 | 0 |
| Isopropyl Alcohol | 11.6 | 19.0 | 19.0 |
| Glycerin | 0.5 | 0.5 | 0.5 |
| pH* | 6.5 | 9.0 | 11.0 |
| Color (b* value) | 1.1 | 3.0 | 10.0 |

*Citric acid is included at a concentration to adjust the pH of the composition to the pH or pH range listed in the table.

### Example II—Formulation Examples

Table III includes a range of possible formulations according to the disclosure. In Table III, citric acid is included at a concentration to adjust the pH of the composition to the pH or pH range listed in the table.

TABLE III

| Ingredient (weight | | | | | |
|---|---|---|---|---|---|
| percent) | K | L | M | N | O |
| Water | QS | QS | QS | QS | QS |
| Sodium Citrate | 0.92 | 0.92 | 0.92 | 0.92 | 0.92 |
| Sodium Lauryl Sulfate | 6 | 6 | 8.5 | 8.5 | 6 |
| Cornmint Oil | 2.0 | 2.5 | 2.0 | 1.5 | 2.0 |
| Lemongrass Oil | 0.3 | 0.5 | 0.8 | 1.0 | 0.9 |
| Isopropyl Alcohol | 11.6 | 11.6 | 19 | 19 | 11.6 |
| Glycerin | 0.5 | 0.5 | 1.0 | 1.0 | 0.5 |
| Nitrogen | 0.00 | 0.00 | 0.70 | 0.70 | 0.70 |
| Citric Acid | adjust to | adjust to pH | adjust to | Adjust to pH | Adjust to pH |
| | pH 6-7 | 6-7 | pH 6-7 | 6-7 | 6-7 |

### Combinations

Paragraph 1. A pest control composition comprising:
a. from about 4% to about 9%, preferably from about 5% to about 9%, by weight of the composition of sodium lauryl sulfate;
b. from about 0.3% to about 2%, by weight of the composition of a first active ingredient, wherein the first active ingredient is lemongrass oil;
c. from about 3% to about 35%, preferably from about 8% to about 20%, by weight of the composition of isopropyl alcohol;
d. from about 65% to about 85% by weight of the composition of water;
wherein the composition has a pH of about 3.0 to about 9.0.
   Paragraph 2. The pest control composition according to Paragraph 1, wherein the composition further comprises from about 2% to about 6% by weight of the composition of a second active ingredient selected from the group consisting of corn mint oil, geraniol, and combinations thereof.
   Paragraph 3. The pest control composition according to Paragraph 2, wherein the composition comprises from about 1% to about 3% by weight of the composition of corn mint oil.
   Paragraph 4. The pest control composition according to Paragraph 2, wherein the weight ratio of sodium lauryl sulfate to the second active ingredient is about 1:1 to about 20:1.
   Paragraph 5. The pest control composition according to any one of Paragraphs 1-4, wherein the composition comprises from about 0.3% to about 1.2% by weight of the composition of the first active ingredient.
   Paragraph 6. The pest control composition according to any one of Paragraphs 1-5, wherein the weight ratio of sodium lauryl sulfate to the first active ingredient is about 2:1 to about 30:1.
   Paragraph 7. The pest control composition according to any one of Paragraphs 1, 5, and 6, wherein the composition is substantially free of active ingredients other than lemongrass oil.
   Paragraph 8. A pest control composition comprising:
a. from about 4% to about 9% by weight of the composition of sodium lauryl sulfate;
b. from about 0.005% to about 2% by weight of the composition of a first active ingredient, wherein the first active ingredient is selected from the group consisting of geranial, neral, limonene, geranyl acetate, caryophyllene, and combinations thereof;
c. from about 0.005% to about 6% by weight of the composition of a second active ingredient, wherein the second active ingredient is selected from the group consisting of geraniol, nerol, menthol, menthone, isomenthone, neomenthol, menthyl acetate, pulegone, 1-8-cineole, camphor, alpha-pinene, beta-pinene, and combinations thereof;
d. from about 3% to about 35% by weight of the composition of isopropyl alcohol;
e. from about 65% to about 85% by weight of the composition of water;
wherein the composition has a pH of about 3.0 to about 9.0.
   Paragraph 9. The pest control composition according to any one of Paragraphs 1-8, wherein the composition further comprises a carboxylic acid selected from the group consisting of citric, malic, acetic, fumaric, humic, and mixtures thereof.
   Paragraph 10. The pest control composition according to Paragraphs 8 or 9, wherein the composition comprises from about 1% to about 3% by weight of the composition of geraniol.
   Paragraph 11. The pest control composition according to any one of Paragraphs 8-10, wherein the weight ratio of sodium lauryl sulfate to total active ingredient is from about 1:3 to about 3:1.
   Paragraph 12. The pest control composition according to any one of Paragraphs 1-11, wherein the composition is stable, preferably stable at 20° C.
   Paragraph 13. The pest control composition according to any one of Paragraphs 1-12, wherein the composition has a turbidity less than about 20 NTU and greater than about 0 NTU.
   Paragraph 14. The pest control composition according to any one of Paragraphs 1-13, wherein the composition has a b* value of about 0 to about 4.
   Paragraph 15. The pest control composition according to any one of Paragraphs 1-14, wherein the composition is an oil-in-water emulsion comprising particles having an intensity mean particle size or volume mean particles size of from about 2 nm to about 100 nm, as measured according to the Particle Size Test Method.
   Paragraph 16. The pest control composition according to any one of Paragraphs 1-15, wherein the composition has a pH of about 5 to about 7.
   Paragraph 17. The pest control composition according to any one of Paragraphs 1-16, wherein the composition comprises from about 3% to about 35% by weight or less of volatile organic compound (VOC).
   Paragraph 18. The pest control composition according to any one of Paragraphs 1-17, wherein the composition is substantially free of synthetic pesticides, mineral oil, colorants, or a combination thereof.
   Paragraph 19. The pest control composition according to any one of Paragraphs 1-18, wherein the composition is packaged in a transparent or translucent container.
   Paragraph 20. The pest control composition according to any one of Paragraphs 1-19, wherein the composition comprises only food use safe ingredients.
   Paragraph 21. The pest control composition according to any one of Paragraphs 1-20, wherein the active ingredients are food use safe.
   Paragraph 22. The pest control composition according to any one of Paragraphs 1-21, wherein the composition is a spray composition.
   Paragraph 23. The pest control composition according to any one of Paragraphs 1-22, wherein the composition further comprises from about 0.01% to about 5% by weight of the composition of glycerin.
   Paragraph 24. A method of controlling a pest, preferably an arthropod pest, on or near food or a food contact surface comprising: i) contacting the pest and the food or food contact surface with a pest control composition according to any one of Paragraphs 1-23; ii) optionally, wiping or rinsing the food or food contact surface, preferably to clean the food contact surface.
   Paragraph 25. The method of Paragraph 24, wherein the food contact surface is selected from the group consisting of countertops, floors, appliances, cookware, cutting boards, utensils, silverware, tables, tableware, tablecloths, placemats, oven mitts, and combinations thereof.
   Paragraph 26. A process for making an aqueous pest control composition, wherein the composition comprises sodium lauryl sulfate, a solvent selected from the group consisting of isopropyl alcohol, glycerin, and mixtures thereof, and a hydrophobic active ingredient selected from the group consisting of corn mint oil, lemongrass oil, geraniol, and mixtures thereof, the process comprising the steps of:
a. combining the sodium lauryl sulfate, the hydrophobic active ingredient, and the solvent, to make an active ingredient premix;
b. combining the active ingredient premix with an aqueous phase comprising water and an optional ingredient selected from a pH modifying agent, a preservative, or mixture thereof to form the aqueous pest control composition;
wherein the aqueous pesticidal composition has a pH of about 3 to about 9, a turbidity less than about 20 NTU and greater than about 0 NTU, and a b value of about 0 to about 4.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A pest control composition comprising:
a. from about 4% to about 9%, by weight of the composition, of sodium lauryl sulfate;
b. from about 0.3% to about 2%, by weight of the composition, of a first active ingredient, wherein the first active ingredient is lemongrass oil;
c. from about 3% to about 35%, by weight of the composition, of isopropyl alcohol;
d. from about 65% to about 85%, by weight of the composition, of water;
wherein the composition has a pH of about 3.0 to about 9.0.

2. The pest control composition according to claim 1, wherein the composition further comprises from about 2% to about 6%, by weight of the composition, of a second active ingredient selected from the group consisting of corn mint oil, geraniol, and combinations thereof.

3. The pest control composition of claim 2, wherein the composition comprises from about 1% to about 3%, by weight of the composition of corn mint oil.

4. The pest control composition of claim 2, wherein the weight ratio of sodium lauryl sulfate to the second active ingredient is about 1:1 to about 20:1.

5. The pest control composition of claim 1, wherein the composition comprises from about 0.3% to about 1.2%, by weight of the composition, of the first active ingredient.

6. The pest control composition of claim 1, wherein the weight ratio of sodium lauryl sulfate to the first active ingredient is about 2:1 to about 30:1.

7. The pest control composition 5, wherein the composition is substantially free of active ingredients other than lemongrass oil.

8. The pest control composition of claim 1, wherein the composition comprises only food use safe ingredients.

9. The pest control composition of claim 1, wherein the composition has a turbidity less than about 20 NTU and greater than about 0 NTU.

10. The pest control composition of claim 1, wherein the composition has a b* value of about 0 to about 4.

11. A pest control composition comprising:
a. from about 4% to about 9%, by weight of the composition, of sodium lauryl sulfate;
b. from about 0.005% to about 2%, by weight of the composition, of a first active ingredient, wherein the first active ingredient is selected from the group consisting of geranial, neral, limonene, geranyl acetate, caryophyllene, and combinations thereof;
c. from about 0.005% to about 6%, by weight of the composition, of a second active ingredient, wherein the second active ingredient is selected from the group consisting of geraniol, nerol, menthol, menthone, isomenthone, neomenthol, menthyl acetate, pulegone, 1-8-cineole, camphor, alpha-pinene, beta-pinene, and combinations thereof;
d. from about 3% to about 35%, by weight of the composition, of isopropyl alcohol;
e. from about 65% to about 85%, by weight of the composition, of water;
wherein the composition has a pH of about 3.0 to about 9.0.

12. The pest control composition of claim 11, wherein the composition further comprises a carboxylic acid selected from the group consisting of citric, malic, acetic, fumaric, humic, and mixtures thereof.

13. The pest control composition of claim 11, wherein the composition comprises from about 1% to about 3%, by weight of the composition, of geraniol.

14. The pest control composition of claim 11, wherein the weight ratio of sodium lauryl sulfate to total active ingredient is from about 1:3 to about 3:1.

15. The pest control composition of claim 11, wherein the composition is an oil-in-water emulsion comprising particles having an intensity mean particle size of from about 2 nm to about 100 nm, as measured according to the Particle Size Test Method.

16. The pest control composition of claim 11, wherein the composition has a pH of about 5 to about 7.

17. The pest control composition of claim 11, wherein the composition comprises from about 3% to about 35% by weight or less of volatile organic compound (VOC).

18. The pest control composition of claim 11, wherein the composition is substantially free of synthetic pesticides, mineral oil, colorants, or a combination thereof.

19. The pest control composition of claim 11, wherein the composition is packaged in a transparent or translucent container.

20. The pest control composition of claim 11, wherein the active ingredients are food use safe, preferably all the ingredients are food use safe.
